(19) United States
(12) Patent Application Publication
(10) Pub. No.: US 2016/0093246 A1
(43) Pub. Date: Mar. 31, 2016

(54) BATTERYLESS DIGITAL INFORMATION DISPLAY DEVICE AND APPARATUS FOR MANAGING THE SAME

(71) Applicant: Jae Ha PARK, Namyangju-si (KR)

(72) Inventor: Jae Ha PARK, Namyangju-si (KR)

(21) Appl. No.: 14/563,223

(22) Filed: Dec. 8, 2014

Related U.S. Application Data
(63) Continuation of application No. PCT/KR2014/011825, filed on Dec. 4, 2014.

(30) Foreign Application Priority Data
Sep. 30, 2014 (KR) 10-2014-0130714

(51) Int. Cl. G09G 3/20

(52) U.S. Cl. CPC G09G 3/2096; G09G 2380/04; G09G 2330/02; G09G 2320/04

(57) ABSTRACT

A batteryless digital information display device includes a display unit including an electronic-paper (e-paper) display module configured to maintain information displayed thereon in absence of power supply, an interface unit configured to receive data from an external device management apparatus and to receive power from the device management apparatus, and a control unit configured, upon being connected to the device management apparatus, to supply the power from the device management apparatus to the e-paper display module via the interface unit and to update information displayed on the e-paper display module based on the data received from the device management apparatus via the interface unit.

### CROSS-REFERENCE TO RELATED APPLICATIONS

This application is a continuation of International Application No. PCT/KR2014/011825, filed Dec. 4, 2014, which is based upon and claims the benefit of priority from Korean Patent Application No. 10-2014-0130714, filed on Sep. 30, 2014, the contents of which are incorporated herein by reference in its entirety.

### BACKGROUND

1. Field

The present disclosure relates to a batteryless digital information display device and an apparatus for managing the batteryless digital information display device, and more particularly, to a batteryless digital information display device for displaying information through an electronic paper (e-paper) display module and an apparatus for managing the batteryless digital information display device.

2. Description of the Related Art

A currently-used information display tag made of paper or plastic is not easy to change printed information thereon or to add new information to the printed information. Such a case generally requires a process of discarding an existing information display tag and a process of producing a new information display tag, which is likely to cause a problem of wasting resources, time, labor, and the like.

KR Pub. No. 2012-0136021 describes a method and an apparatus for displaying video contents by using an e-paper as a display medium. In the method and apparatus described in KR Pub. No. 2012-0136021, an auxiliary processor having low power consumption is separately used, so that a power supply to a main processor is turned on and off as appropriate.

### SUMMARY

According to some embodiments, a batteryless digital information display device includes a display unit including an electronic-paper (e-paper) display module configured to maintain information displayed thereon in absence of power supply, an interface unit configured to receive data from an external device management apparatus, and to receive power from the device management apparatus, and a control unit configured, upon being connected to the device management apparatus, to supply the power from the device management apparatus to the e-paper display module via the interface unit and to update information displayed on the e-paper display module based on the data received from the device management apparatus via the interface unit.

According to some embodiments, a device management apparatus includes an interface unit, an input unit configured to receive an input of an operation from a user, a display unit configured to display information thereon, and a control unit configured, upon being connected to a batteryless digital information display device via the interface unit, to display output information outputted as a result of the operation from the user on the display unit, to transmit the output information to the batteryless digital information display device via the interface unit, and to supply power to the batteryless digital information display device via the interface unit.

According to some embodiments, a batteryless digital information display device includes a display unit including an e-paper display module configured to maintain information displayed thereon in absence of power supply and an interface unit configured to receive data from an external device management apparatus, and to receive power from the device management apparatus.

The above and other objects, features, advantages and technical and industrial significance of this disclosure will be better understood by reading the following detailed description of exemplary embodiments of the disclosure, when considered in connection with the accompanying drawings.

### BRIEF DESCRIPTION OF THE DRAWINGS

FIG. 1 is a block diagram of a batteryless digital information display device and a device management apparatus according to some embodiments;

FIG. 2 is a schematic diagram illustrating an operation in which the batteryless digital information display device and the device management apparatus shown in FIG. 1 are connected to each other;

FIG. 3 is a schematic diagram illustrating a configuration of the batteryless digital information display device shown in FIG. 1;

FIG. 4 is a schematic diagram of an example of the batteryless digital information display device shown in FIG. 1;

FIG. 5 is a schematic diagram of an example of an information display area according to some embodiments;

FIG. 6 is a schematic diagram of another example of the information display area according to some embodiments;

FIG. 7 is a schematic diagram of another example of the batteryless digital information display device according to some embodiments;

FIG. 8 is a schematic diagram illustrating an example of displaying in-room information on the batteryless digital information display device according to some embodiments;

FIG. 9 is a schematic diagram illustrating an example of displaying reservation status information on the batteryless digital information display device according to some embodiments;

FIG. 10 is a schematic diagram illustrating an example of displaying doctor's rounds information on the batteryless digital information display device according to some embodiments;

FIG. 11 is a schematic diagram illustrating an example of displaying clinical information on the batteryless digital information display device according to some embodiments;

FIG. 12 is a schematic diagram illustrating an example of displaying advertisement information on the batteryless digital information display device according to some embodiments;

FIG. 13 is a schematic diagram illustrating an example of displaying calendar information on the batteryless digital information display device according to some embodiments;

FIG. 14 is a schematic diagram illustrating an example of displaying product price information on the batteryless digital information display device according to some embodiments;

FIG. 15 is a schematic diagram illustrating another example of displaying product price information on the batteryless digital information display device according to some embodiments;

FIG. 16 is a schematic diagram illustrating an example of displaying personal identification information on the batteryless digital information display device according to some embodiments;

FIG. 17 is a schematic diagram illustrating an example of displaying room information on the batteryless digital information display device according to some embodiments;

FIG. 18 is a schematic diagram illustrating an example of displaying cultural property information on the batteryless digital information display device according to some embodiments;

FIG. 19 is a schematic diagram illustrating an example of displaying conference information on the batteryless digital information display device according to some embodiments;

FIG. 20 is a schematic diagram illustrating an example of displaying e-wall information on the batteryless digital information display device according to some embodiments;

FIG. 21 is a schematic diagram illustrating an example of displaying meeting board information on the batteryless digital information display device according to some embodiments;

FIG. 22 is a schematic diagram illustrating an example of displaying exhibition badge information on the batteryless digital information display device according to some embodiments;

FIG. 23 is a schematic diagram illustrating an example of displaying patient identification tag information on the batteryless digital information display device according to some embodiments; and

FIG. 24 is a block diagram of the device management apparatus shown in FIG. 1.

### DETAILED DESCRIPTION OF THE PREFERRED EMBODIMENTS

Exemplary embodiments of the present disclosure are described in detail below with reference to the accompanying drawings.

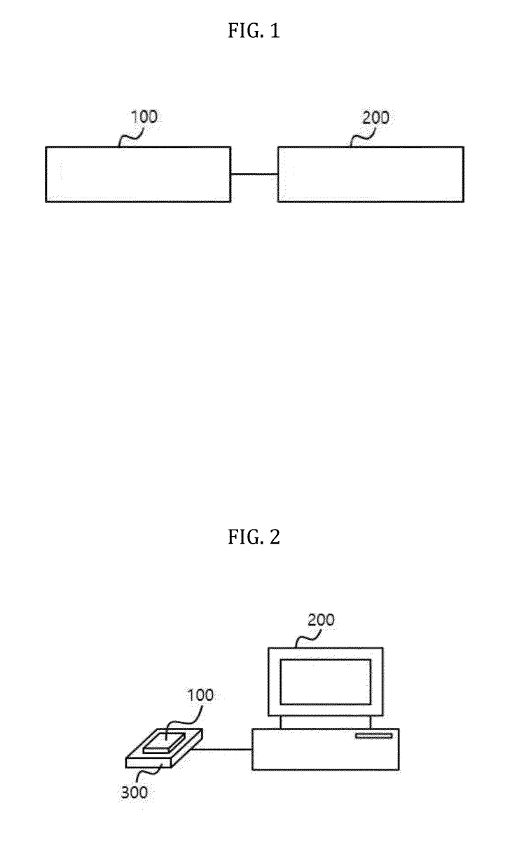

A batteryless digital information display device and a device management apparatus according to some embodiments are described below with reference to FIGS. 1 and 2.

FIG. 1 is a block diagram of a batteryless digital information display device 100 and a device management apparatus 200 according to some embodiments.

The batteryless digital information display device 100 displays various pieces of information via an e-paper display module. The e-paper display module is a display medium that can be used like a paper, and is often referred to as an “e-paper”. The e-paper display module is widely used for a portable electronic book due to the low power consumption. In addition, the e-paper display module is configured to maintain the information displayed thereon in absence of power supply.

The batteryless digital information display device 100 is configured to be connected to the device management apparatus 200, and to update the information displayed on the e-paper display module. To this end, the device management apparatus 200 supplies output information created by an operation of a user to the batteryless digital information display device 100, and upon receiving the output information, the batteryless digital information display device 100 updates the information by displaying the output information received from the device management apparatus 200 on the e-paper display module.

FIG. 2 is a schematic diagram illustrating an operation in which the batteryless digital information display device 100 and the device management apparatus 200 shown in FIG. 1 are connected to each other

Referring to FIG. 2, a cradle 300 is connected to the device management apparatus 200 via a cable. The batteryless digital information display device 100 is then connected to the cradle 300 via a pin connector module or a near field communication (NFC) module.

The cradle 300 supplies power to the batteryless digital information display device 100, and supplies data from the device management apparatus 200 to the batteryless digital information display device 100.

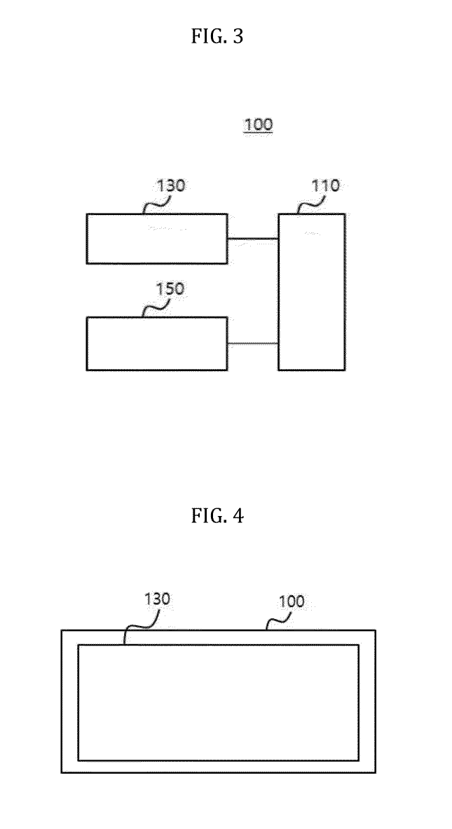

Referring to FIGS. 3 and 4, the batteryless digital information display device 100 according to some embodiments is described in detail.

FIG. 3 is a schematic diagram illustrating a configuration of the batteryless digital information display device 100 shown in FIG. 1, and FIG. 4 is a schematic diagram of an example of the batteryless digital information display device 100 shown in FIG. 1.

As shown in FIGS. 3 and 4, the batteryless digital information display device 100 includes an interface unit 110, a display unit 130, and a control unit 150.

The interface unit 110 includes a pin connector module (not shown) or an NFC module (not shown), and receives the data from the device management apparatus 200 via the cradle 300. Further, the interface unit 110 receives the power from the device management apparatus 200 via the cradle 300.

The display unit 130 includes an e-paper display module (not shown), and displays various pieces of information via the e-paper display module. The e-paper display module maintains the information displayed thereon in absence of power supply. That is, even when the batteryless digital information display device 100 is disconnected from the cradle 300 so that the power supply from the device management apparatus 200 is stopped, the information displayed on the e-paper display module is maintained.

The control unit 150 is implemented with a processor or a central processing unit (CPU) that controls overall operations of the constituent elements. In particular, the control unit 150 according to some embodiments operates with the power supplied from the device management apparatus 200 via the interface unit 110 that is connected to the device management apparatus 200 via the cradle 300, and supplies the power from the device management apparatus 200 to the e-paper display module.

The control unit 150 according to some embodiments updates the information displayed on the e-paper display module, based on the data received from the device management apparatus 200 via the interface unit 110.

That is, the batteryless digital information display device 100 is configured to receive the power from the device management apparatus 200 via the cradle 300, and updates the information displayed on the display unit 130 only when the information displayed on the display unit 130 is to be changed.

In the example shown in FIG. 3, the batteryless digital information display device 100 includes the control unit 150. However, the batteryless digital information display device 100 according to some embodiments includes only the interface unit 110 and the display unit 130. In this case, the control unit 150 is included in the device management apparatus 200 to perform the above-mentioned functions.

In some embodiments, the e-paper display module includes an information display area to display the information, and the information display area is divided into a plurality of areas. Among the plurality of areas, a first area is used to display stationary information, and a second area is used to display variable information. When the information displayed on the e-paper display module includes the stationary information and the variable information, the batteryless digital information display device 100 updates the second area. That is, in some embodiments, the control unit 150 updates information in the second area, based on the data received from the device management apparatus 200 via the interface unit 110.

For example, when employee information, which is one of pieces of personal identification information, is displayed on the e-paper display module, information of “company name” and the like is displayed in the first area, and information of “name”, “affiliation”, “contact”, and the like is displayed in the second area (electronic name tag).

When the information display area is divided into the first area and the second area, in some embodiments, each of the first area and the second area includes a plurality of sub-areas.

In some embodiments, the information displayed on the e-paper display module includes at least one of in-room information, reservation status information, doctor's rounds information, clinical information, advertisement information, calendar information, product price information, personal identification information, room information, cultural property information, conference information, e-wall information, meeting board information, exhibition badge information, or patient identification tag information.

The in-room information refers to information on a person in a specific place, such as information on a patient who is in a hospital room. The reservation status information refers to information on a person who made a reservation on a restaurant, a conference room, or the like. The doctor's rounds information refers to information on a schedule of everyday doctor's rounds in a hospital. The clinical information refers to information on a patient who is in hospital. The advertisement information refers to information on an advertisement created for the purpose of discount, marketing, promotion, or the like. The calendar information refers to information on a calendar. The product price information refers to information on a price of a product such as apparel, food, or the like. The personal identification information refers to information for identifying a person, such as an employee, an exhibition attendee, a patient, or the like. The room information refers to information on a room number plate of a hotel. The cultural property information refers to information on a cultural property. The conference information refers to information on a conference attendee or information on a conference agenda. The e-wall information refers to event information or the like displayed on a wall. The meeting board information refers to information on a room number, name of an attendee, or the like. The exhibition badge information refers to information on name of an exhibition, a place, name of an attendee, or the like. The patient identification tag information refers to information on name, age, sex, or the like of a patient.

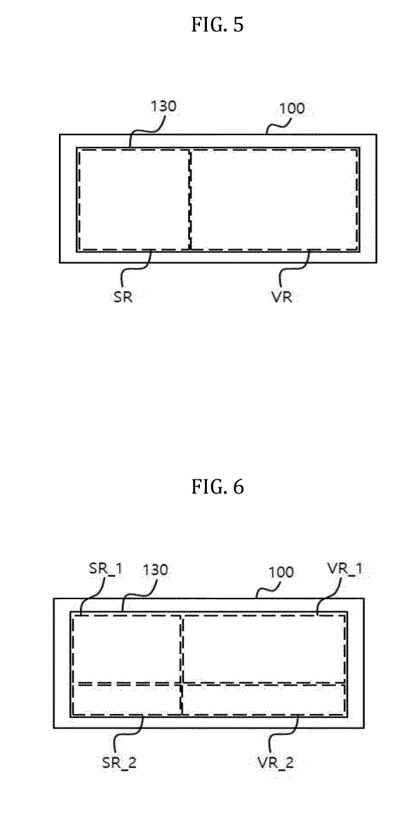

The information display area according to some embodiments is described with reference to FIGS. 5 and 6.

FIG. 5 is a schematic diagram of an example of the information display area according to some embodiments.

In the example shown in FIG. 5, the information display area on the display unit 130 of the batteryless digital information display device 100 includes a stationary area (SR) where the stationary information is displayed and a variable area (VR) where the variable information is displayed.

FIG. 6 is a schematic diagram of another example of the information display area according to some embodiments.

In the example shown in FIG. 6, the information display area on the display unit 130 of the batteryless digital information display device 100 includes a first stationary area (SR_1) and a second stationary area (SR_2) where the stationary information is displayed and a first variable area (VR_1) and a second variable area (VR_2) where the variable information is displayed.

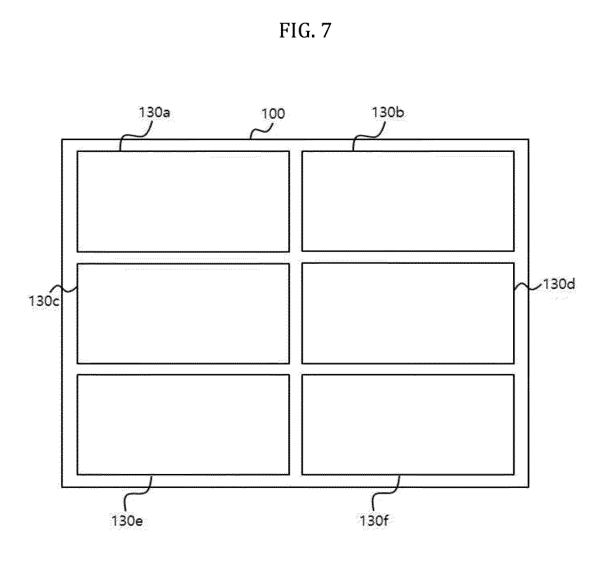

Another example of the batteryless digital information display device 100 according to some embodiments is described with reference to FIG. 7.

FIG. 7 is a schematic diagram of another example of the batteryless digital information display device 100 according to some embodiments.

In the example shown in FIG. 4, the batteryless digital information display device 100 includes a single display unit 130. However, the number of display units 130 is not limited to one, but can be any number. For example, the batteryless digital information display device 100 can include a plurality of display units 130 depending on various embodiments.

In the example shown in FIG. 7, the batteryless digital information display device 100 includes six display units 130a to 130f. The number of display units 130 included in the batteryless digital information display device 100 can be increased or decreased as appropriate.

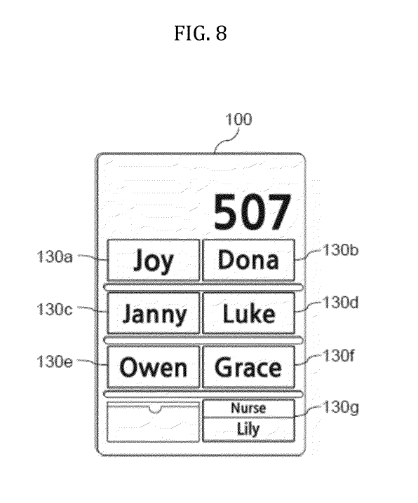

Examples of displaying information on the batteryless digital information display device 100 according to some embodiments are described with reference to FIGS. 8 to 23.

FIG. 8 is a schematic diagram illustrating an example of displaying in-room information on the batteryless digital information display device 100 according to some embodiments.

In the example shown in FIG. 8, the batteryless digital information display device 100 includes seven display units 130a to 130g. The batteryless digital information display device 100 further includes a predetermined area for displaying information for identifying a room number. Among the seven display units 130a to 130g, six display units 130a to 130f are used to display information for identifying the respective patients accommodated in the rooms (e.g., name), and the display unit 130g is used to display information for identifying nurses who take care of the respective rooms (e.g., name).

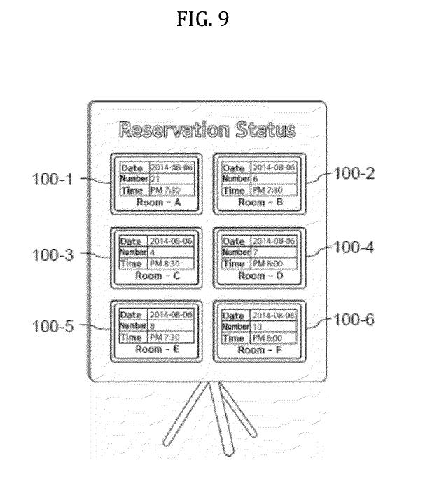

FIG. 9 is a schematic diagram illustrating an example of displaying reservation status information on the batteryless digital information display device 100 according to some embodiments.

In the example shown in FIG. 9, six batteryless digital information display devices 100-1 to 100-6 are arranged on a reservation status board. Each of the six batteryless digital information display devices 100-1 to 100-6 displays conference room reservation information (e.g., room number, date, number of attendees, and time).

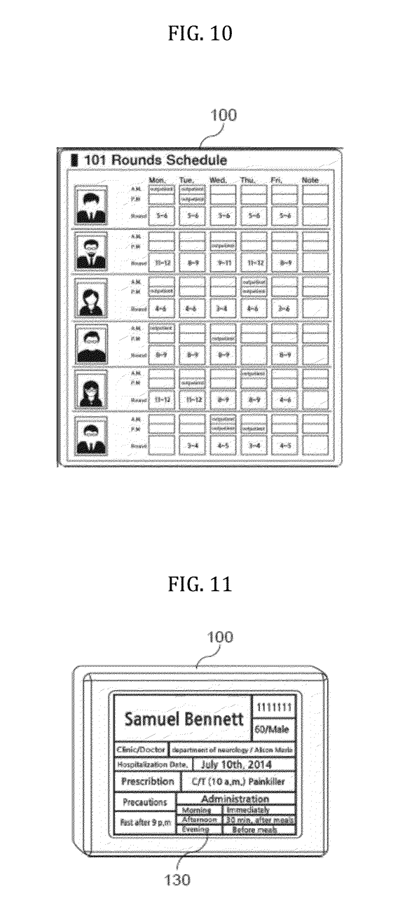

FIG. 10 is a schematic diagram illustrating an example of displaying doctor's rounds information on the batteryless digital information display device 100 according to some embodiments.

In the example shown in FIG. 10, the batteryless digital information display device 100 displays information on doctor's rounds schedule in a hospital (e.g., doctor's photo and schedule of rounds).

FIG. 11 is a schematic diagram illustrating an example of displaying clinical information on the batteryless digital information display device 100 according to some embodiments.

In the example shown in FIG. 11, the batteryless digital information display device 100 displays information on a patient in hospital (e.g., patient's name, diagnosis and treatment department, doctor in charge, and disease name).

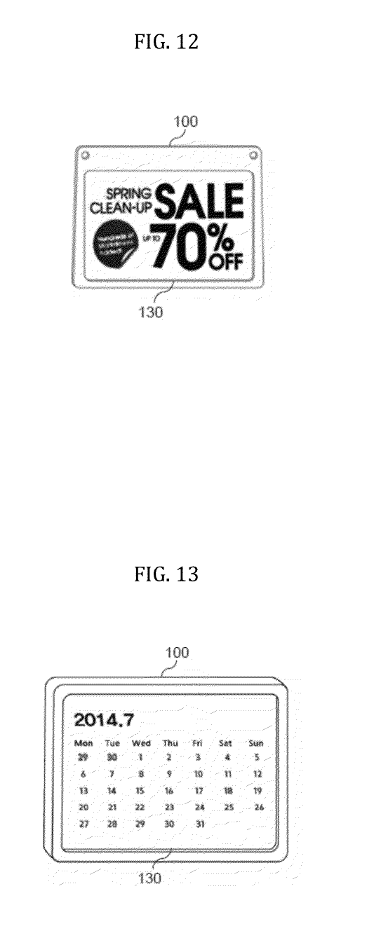

FIG. 12 is a schematic diagram illustrating an example of displaying advertisement information on the batteryless digital information display device 100 according to some embodiments.

In the example shown in FIG. 12, the batteryless digital information display device 100 displays information on an advertisement created for the purpose of discount, marketing, promotion, or the like (e.g., discount period and discount rate).

FIG. 13 is a schematic diagram illustrating an example of displaying calendar information on the batteryless digital information display device 100 according to some embodiments.

In the example shown in FIG. 13, the batteryless digital information display device 100 displays current or desired calendar information.

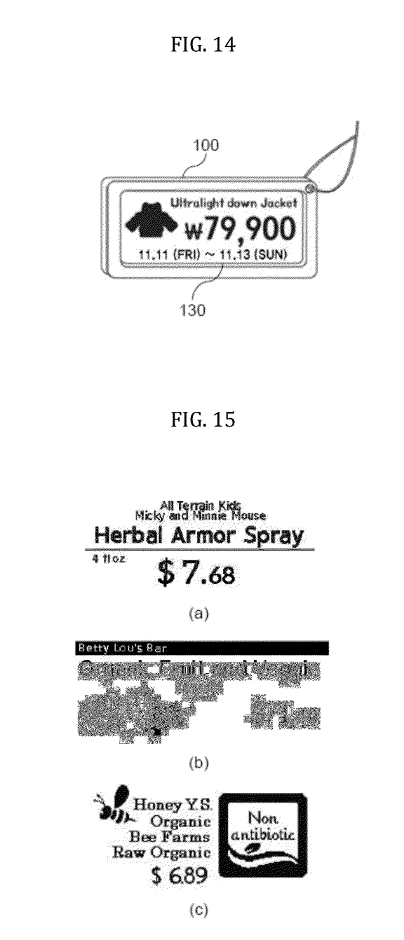

FIG. 14 is a schematic diagram illustrating an example of displaying product price information on the batteryless digital information display device 100 according to some embodiments, and FIG. 15 is a schematic diagram illustrating another example of displaying product price information on the batteryless digital information display device 100 according to some embodiments.

In the example shown in FIG. 14, the batteryless digital information display device 100 displays information on a product price such as a price of apparel, food, or the like (e.g., name and price of a product). The product price displayed by the batteryless digital information display device 100 can be displayed in various forms as shown in FIG. 15.

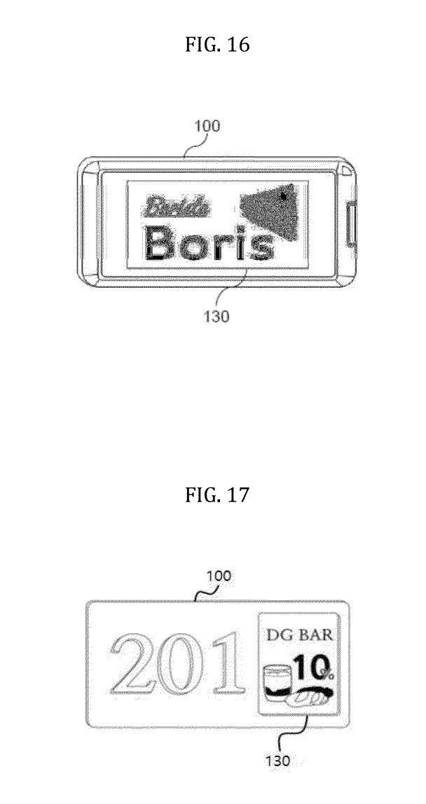

FIG. 16 is a schematic diagram illustrating an example of displaying personal identification information on the batteryless digital information display device 100 according to some embodiments.

In the example shown in FIG. 16, the batteryless digital information display device 100 displays personal identification information for identifying a person such as an employee, an exhibition attendee, a patient, or the like (e.g., company logo, position, and name).

FIG. 17 is a schematic diagram illustrating an example of displaying room information on the batteryless digital information display device 100 according to some embodiments.

In the example shown in FIG. 17, the batteryless digital information display device 100 includes a first area and a second area. Information for identifying a room number is displayed in the first area, and the display unit 130 is located in the second area. The batteryless digital information display device 100 displays room information (e.g., discount information for guests) on the display unit 130.

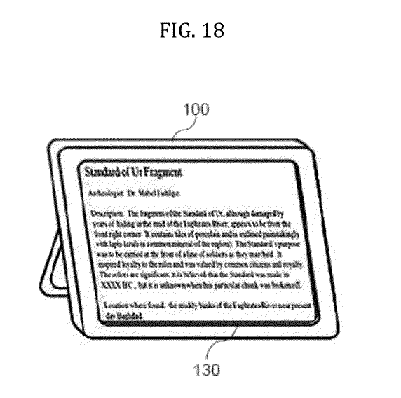

FIG. 18 is a schematic diagram illustrating an example of displaying cultural property information on the batteryless digital information display device 100 according to some embodiments.

In the example shown in FIG. 18, the batteryless digital information display device 100 displays information on a cultural property such as a historic site.

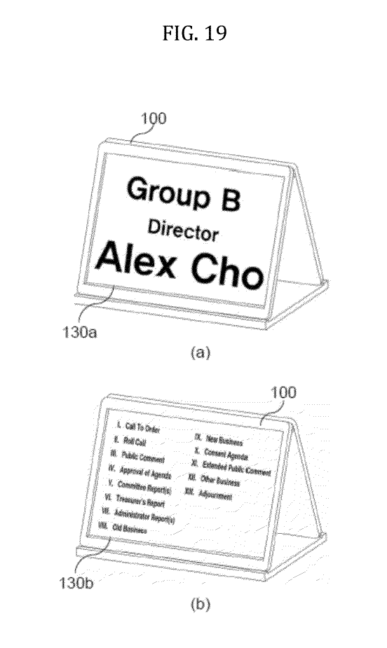

FIG. 19 is a schematic diagram illustrating an example of displaying conference information on the batteryless digital information display device 100 according to some embodiments.

In the example shown in FIG. 19, the batteryless digital information display device 100 includes two display units 130a and 130b, and displays conference information on the two display units 130a and 130b. For example, the batteryless digital information display device 100 displays information on a conference attendee (e.g., name and affiliation) on the display unit 130a and information on a conference agenda on the display unit 130b.

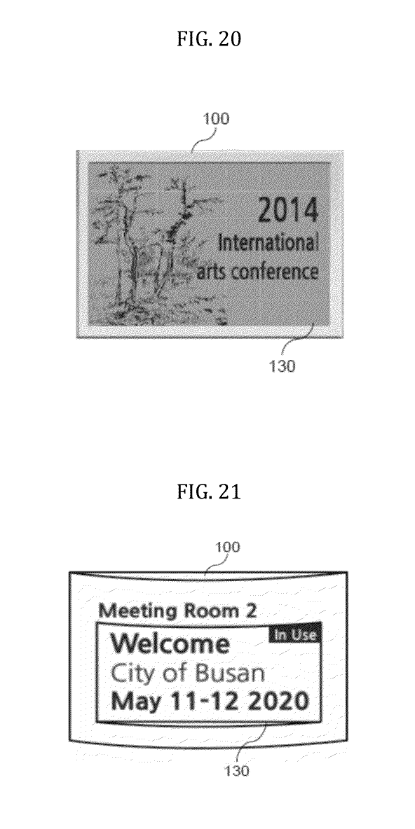

FIG. 20 is a schematic diagram illustrating an example of displaying e-wall information on the batteryless digital information display device 100 according to some embodiments.

In the example shown in FIG. 20, the batteryless digital information display device 100 includes a plurality of display units 130, and displays e-wall information (e.g., event information) by coupling the plurality of display units 130, which are physically separated, as a single logical display unit. In some embodiments, the display units 130 are logically coupled in a multivision form.

FIG. 21 is a schematic diagram illustrating an example of displaying meeting board information on the batteryless digital information display device 100 according to some embodiments.

In the example shown in FIG. 21, the batteryless digital information display device 100 displays meeting board information (e.g., meeting topic).

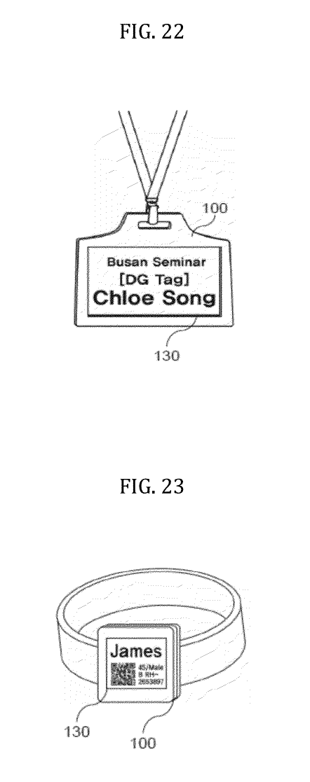

FIG. 22 is a schematic diagram illustrating an example of displaying exhibition badge information on the batteryless digital information display device 100 according to some embodiments.

In the example shown in FIG. 22, the batteryless digital information display device 100 displays exhibition badge information (e.g., exhibition name, place, and attendee name).

FIG. 23 is a schematic diagram illustrating an example of displaying patient identification tag information on the batteryless digital information display device 100 according to some embodiments.

In the example shown in FIG. 23, the batteryless digital information display device 100 displays patient identification tag information in a hospital (e.g., name, age, sex, and QR code for identifying a patient).

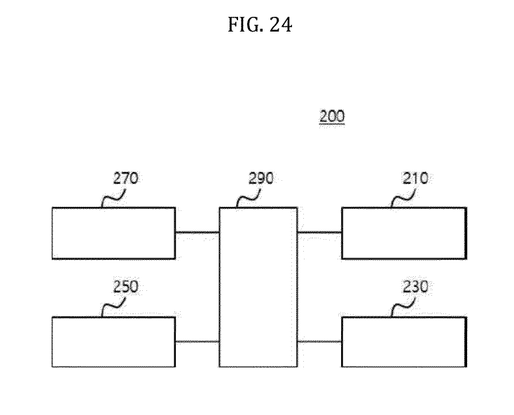

The device management apparatus 200 according to some embodiments is described in detail below with reference to FIG. 24.

FIG. 24 is a block diagram of the device management apparatus 200 shown in FIG. 1.

As shown in FIG. 24, the device management apparatus 200 includes a display unit 210, an input unit 230, a storage unit 250, an interface unit 270, and a control unit 290.

The display unit 210 visually provides a user with a menu of the device management apparatus 200, input data, function setting information, and other various pieces of information. The display unit 210 has a function of outputting a data edit screen, a template select screen, and the like.

In some embodiments, the display unit 210 includes a liquid crystal display (LCD), an organic light emitting diode (OLED) display, an active matrix organic light emitting diode (AMOLED) display, a flexible display (FD), a three-dimensional (3D) display, an e-paper, and the like.

In some embodiments, the input unit 230 receives an input for controlling an operation of the device management apparatus 200 from a user, generates an input signal, and transfers the input signal to the control unit 290. In some embodiments, the input unit 230 is connected to an external input device (not shown) such as a keyboard and a mouse, and receives the input signal from the external input device.

The storage unit 250 stores therein program and data required for the operation of the device management apparatus 200, and is divided into a program area and a data area. The program area is an area where a program for controlling overall operations of the device management apparatus 200, an operating system (OS) for booting the device management apparatus 200, an application program required to edit data, and the like are stored. The data area is an area where data generated by a use of the device management apparatus 200, such as image data and text data, are stored.

The interface unit 270 supplies the data to the batteryless digital information display device 100 via the cradle 300. Further, the interface unit 270 supplies the power to the batteryless digital information display device 100 via the cradle 300.

The control unit 290 controls overall operations for each constituent element of the device management apparatus 200. In particular, the control unit 290 according to some embodiments supplies an output by a user's operation via the input unit 230 to the batteryless digital information display device 100 via the interface unit 270.

That is, the control unit 290 displays output information from the user's operation via the input unit 230 on the display unit 210. The output information includes at least one of in-room information, reservation status information, doctor's rounds information, clinical information, advertisement information, calendar information, product price information, personal identification information, room information, cultural property information, conference information, e-wall information, meeting board information, exhibition badge information, or patient identification tag information.

The control unit 290 then transmits the output information to the batteryless digital information display device 100 via the interface unit 270. Upon receiving a transfer operation via the input unit 230 when the output information is being displayed on the display unit 210, the control unit 290 transmits the output information to the batteryless digital information display device 100 via the interface unit 270. In addition, the control unit 290 supplies power to the batteryless digital information display device 100 via the interface unit 270. The batteryless digital information display device 100 then supplies the power to the e-paper display module from device management apparatus 200, and updates the information displayed on the e-paper display module based on the output information received from the device management apparatus 200.

In some embodiments, the output information is created based on a template displayed on the display unit 210. That is, the user can create desired image information by using the template displayed on a screen of the display unit 210.

The present disclosure can be implemented as a code on a recording medium that is readable by a computer. The computer-readable recording medium includes any type of recoding medium on which computer-readable data can be stored. The computer-readable recording medium includes a ROM, a RAM, a CD-ROM, a magnetic type, a flexible disk, an optical disk, and the like, and further includes one implemented by a carrier wave (which can be transmitted through the Internet). Further, the computer-readable recording medium can be stored on computers connected to one another via a wired or wireless communication network in a distributed manner as a code that is readable by the computers in a distributed manner.

In some embodiments, the batteryless digital information display device 100 further includes a first connector (not shown) that is one side of a universal connector, to which the interface unit 110 is connected, and the first connector is coupled with a second connector (not shown) that is the other side of the universal connector and included in the cradle 300, to establish an electrical connection to the device management apparatus 200.

In some embodiments, the interface unit 110 of the batteryless digital information display device 100 receives the data and the power from the device management apparatus 200 via a wired connection.

In some embodiments, the interface unit 110 of the batteryless digital information display device 100 receives the data and the power from the device management apparatus 200 via a wireless connection.

In some embodiments, the device management apparatus 200 includes a first connector (not shown) that is one side of a universal connector, to which the interface unit 270 is connected, and the first connector is coupled to a second connector that is the other side of the universal connector included in the batteryless digital information display device 100, to establish an electrical connection to the batteryless digital information display device 100.

In some embodiments, the interface unit 270 transmits the output information to the batteryless digital information display device 100 and supplies the power to the batteryless digital information display device 100 via a wired connection.

In some embodiments, the interface unit 270 transmits the output information to the batteryless digital information display device 100 and supplies the power to the batteryless digital information display device 100 via a wireless connection.

It is an object of the present disclosure to provide a batteryless digital information display device configured to display information via an e-paper display module without a battery, and to update the information displayed on the e-paper display module with power supplied from outside only when updating the information, and an apparatus for managing the batteryless digital information display device.

According to the batteryless digital information display device and the device management apparatus of some embodiments, by displaying information on the e-paper display module without a battery and updating the displayed information with power supplied from outside only when updating the information, even when changing currently displayed information or adding new information, the information can be simply and easily updated. In addition, because the batteryless digital information display device can be repeatedly used, waste of the resources can be avoided and the maintenance cost can be minimized.

Additional advantages and modifications will readily occur to those skilled in the art. Therefore, the disclosure in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A batteryless digital information display device, comprising:
a display unit including an electronic-paper (e-paper) display module configured to maintain information displayed thereon in absence of power supply;
an interface unit configured to receive data from an external device management apparatus and to receive power from the device management apparatus; and
a control unit configured, upon being connected to the device management apparatus, to supply the power from the device management apparatus to the e-paper display module via the interface unit and to update information displayed on the e-paper display module based on the data received from the device management apparatus via the interface unit.

2. The batteryless digital information display device according to claim 1, wherein
the e-paper display module includes an information display area configured to display the information,
the information includes stationary information and variable information, and
the information display area includes
a first information display area configured to display the stationary information, and
a second information display area configured to display the variable information.

3. The batteryless digital information display device according to claim 2, wherein the control unit is configured to update the variable information displayed in the second information display area based on the data received from the device management apparatus.

4. The batteryless digital information display device according to claim 1, wherein
the e-paper display module includes an information display area configured to display the information,
the information includes stationary information and variable information, and
the information display area includes
a plurality of first information display areas each configured to display stationary information, and
a plurality of second information display areas each configured to display variable information.

5. The batteryless digital information display device according to claim 4, wherein the control unit is configured to update the variable information displayed in at least one of the second information display areas based on the data received from the device management apparatus.

6. The batteryless digital information display device according to claim 1, wherein the information displayed on the e-paper display module includes at least one piece of information selected from the group consisting of in-room information, reservation status information, doctor's rounds information, clinical information, advertisement information, calendar information, product price information, personal identification information, room information, cultural property information, conference information, e-wall information, meeting board information, exhibition badge information, patient identification tag information, and any combination thereof.

7. The batteryless digital information display device according to claim 1, further comprising a first connector that is one side of a universal connector to which the interface unit is connected, wherein
the first connector is configured to be connected to a second connector that is the other side of the universal connector included in the device management apparatus, to establish an electrical connection with the device management apparatus.

8. The batteryless digital information display device according to claim 1, wherein the interface unit receives the data and the power from the device management apparatus via a wired connection.

9. The batteryless digital information display device according to claim 1, wherein the interface unit receives the data and the power from the device management apparatus via a wireless connection.

10. The batteryless digital information display device according to claim 1, wherein the batteryless digital information display device includes an electronic name tag.

11. A device management apparatus, comprising:
an interface unit;
an input unit configured to receive an input of an operation from a user;
a display unit configured to display information thereon; and
a control unit configured, upon being connected to a batteryless digital information display device via the interface unit, to display output information outputted as a result of the operation from the user on the display unit, to transmit the output information to the batteryless digital information display device via the interface unit, and to supply power to the batteryless digital information display device via the interface unit.

12. The device management apparatus according to claim 10, wherein
the display unit is further configured to display a template thereon, and
the output information is created based on the template displayed on the display unit.

13. The device management apparatus according to claim 10, wherein the control unit is configured to transmit the output information to the batteryless digital information display device via the interface unit when a transmission operation is inputted through the input unit in a state in which the output information is displayed on the display unit.

14. The device management apparatus according to claim 10, wherein the output information includes at least one piece of information selected from the group consisting of in-room information, reservation status information, doctor's rounds information, clinical information, advertisement information, calendar information, product price information, personal identification information, room information, cultural property information, conference information, e-wall information, meeting board information, exhibition badge information, patient identification tag information, and any combination thereof.

15. The device management apparatus according to claim 10, further comprising a first connector that is one side of a universal connector to which the interface unit is connected, wherein
the first connector is configured to be connected to a second connector that is the other side of the universal connector included in the batteryless digital information display, to establish an electrical connection with the batteryless digital information display.

16. The device management apparatus according to claim 10, wherein the interface unit is configured to transmit the data and to supply the power to the batteryless digital information display via a wired connection.

17. The device management apparatus according to claim 10, wherein the interface unit is configured to transmit the data and to supply the power to the batteryless digital information display via a wireless connection.

18. A batteryless digital information display device, comprising:
a display unit including an electronic-paper (e-paper) display module configured to maintain information displayed thereon in absence of power supply; and
an interface unit configured to receive data from an external device management apparatus and to receive power from the device management apparatus.

19. The batteryless digital information display device according to claim 18, wherein upon being connected to the device management apparatus, the information displayed on the e-paper display module is updated based on the data received from the device management apparatus via the interface unit.

20. The batteryless digital information display device according to claim 18, wherein the batteryless digital information display device includes an electronic name tag.
